(19) United States
(12) Patent Application Publication
(10) Pub. No.: US 2007/0088969 A1
(43) Pub. Date: Apr. 19, 2007

(54) Method and system for monitoring an accumulated runtime in a device

(76) Inventors: Michael D. Weekley, Tomball, TX (US); Shanawaz S. Kazi, Houston, TX (US); G. Abbas Movakel, Houston, TX (US); Allen G. Siemons, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/248,298

(22) Filed: Oct. 13, 2005

(51) Int. Cl. G06F 1/14

(52) U.S. Cl. 713/502

(57) ABSTRACT

A method and system are disclosed for detecting at least one of: a hardware function and a supply of power from a power supply to the device. The method and system can determine, in response to the detecting, a first parameter representing a runtime of the hardware function, and power supplied by the power supply to the device. The first parameter can be stored in a memory associated with the device for monitoring an accumulated runtime.

### BACKGROUND INFORMATION

A method and system are disclosed for monitoring an accumulated runtime in a device, such as a hand held computer, a laptop computer, a desktop computer, a server, a personal digital assistant (PDA), or any other computer or microprocessor based device, including but not limited to intelligent devices such as field programmable gate arrays (FPGAs), programmable logic arrays (PLAs) or other such devices.

Systems and methods are known for monitoring use characteristics of a device. For example, odometers are used for devices such as automobiles, bicycles, robots and remotely operated vehicles (ROVs).

### SUMMARY

A method is disclosed for monitoring an accumulated runtime in a device, comprising: detecting at least one of: a hardware function and a supply of power from a power supply to the device; determining, in response to the detecting, a first parameter representing a runtime of at least one of the hardware function, and power supplied by the power supply to the device; and storing the first parameter in a memory associated with the device.

A system is disclosed for monitoring an accumulated runtime in a device, comprising: detecting at least one of: a hardware function and a supply of power from a power supply to the device; logic, connected to the detector, for measuring a first parameter representing, a runtime of at least one of the hardware function, and power supplied by the power supply to the device; and memory for storing the first parameter representing the runtime.

A system is also disclosed for monitoring an accumulated runtime in a device, comprising: means for detecting at least one of: a hardware function and a supply of power from a power supply to the device; means for determining, in response to the detecting, a first parameter representing a runtime of at least one of the hardware function, and power supplied by the power supply to the device; and means for storing the first parameter.

### BRIEF DESCRIPTION OF THE DRAWINGS

Other embodiments and advantages will be apparent to those skilled in the art upon reading the detailed description of preferred embodiments in conjunction with the accompanying drawings, wherein:

FIG. 1 shows a block diagram according to a first exemplary embodiment;

FIG. 2 shows an exemplary flow chart regarding operation of a system in accordance with exemplary embodiments described herein; and

FIGS. 3A to 3E show alternate exemplary embodiments described herein.

### DETAILED DESCRIPTION

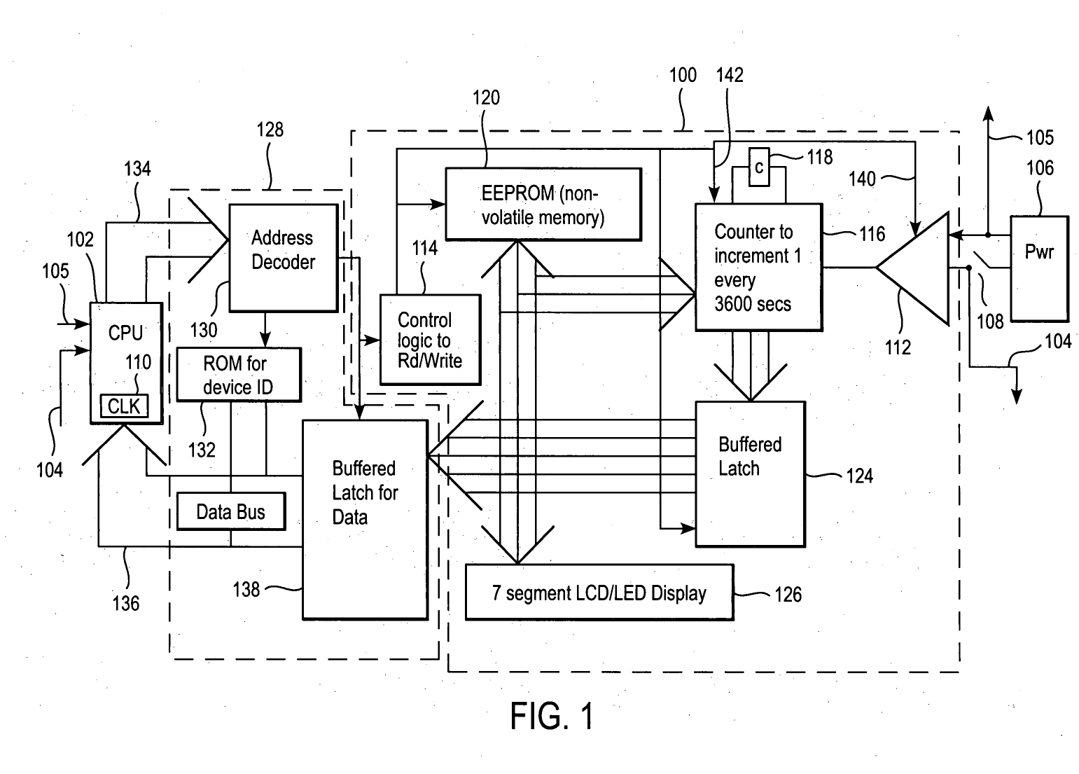

FIG. 1 shows an exemplary stand-alone hardware-based system 100 for monitoring an accumulated runtime within a device 102, represented as a computer having a central processing unit (CPU). Alternately, the system 100 can be used to monitor its own runtime, or any other desired device. As shown in FIG. 1, the computer 102 includes an input 104 for receiving power from a power supply 106 during a power on operation. The power supply 106 can be an auxiliary power supply, such as the power supplied via a wall outlet to power the computer. A power-on switch 108 associated with, or included in, the computer 102 can be used to provide a main power supply to the computer via input 104.

A memory associated with the computer 102 includes, among other programming information, a Basic Input Output System (BIOS). The BIOS can be executed by logic, such as a processor or other logic within the computer 102. In an exemplary embodiment, the computer 102 includes a system clock 110 which is supplied with power from the power supply.

A detector, such as a comparator 112 and/or logic 114, is provided for detecting at least one of a hardware function and a supply of power from a power supply (such as power supply 106) to the system 100. In an exemplary embodiment, both a power supply runtime and a specified hardware function can be separately monitored. In addition, a hardware function associated with execution of a program can be used to initiate and/or terminate the monitoring of the program.

As referenced herein, a “hardware function” is a function performed by any hardware device or device component (e.g., multimeter, or appliance). For example, any hardware device powered by power supply 106 including but not limited to computer 102, can have its function monitored as described herein. Such a device, although receiving power from the power supply, may remain in an inactive state until being turned on (e.g., in response to a software and/or manual command).

The detector can be configured as a single detector having multiple sensors, or can be configured as a plurality of detectors at different locations. In the exemplary embodiment of FIG. 1, the detector includes a means, such as an analog and/or digital comparator 112, for detecting a supply of power. The detector can be used to monitor power from power supply 106 directly to the computer 102 via a separate input 105 (that is, as an auxiliary power supply to computer 102), or to monitor power which passes via the power-on switch 108 to the computer 102.

Alternately, or in addition, the detector can include means, such as logic 114, for detecting a hardware function such as a function that is external to system 100 and associated with the computer 102 or peripheral equipment associated with computer 102. For example, the hardware function can be associated with hardware that is initiated by software running on computer 102. Such a function can be initiated by software including, but not limited to, a basic input/output system (BIOS) program of the computer, an operating system program of the computer, and/or an application program running under control of an operating system of the computer.

Logic, such as a counter 116 having an associated clock 118 (for example, an oscillator), can be connected to the detector, for measuring a first parameter representing a runtime of the monitored hardware function and/or power supplied by the power supply to the device. The first parameter can, in an exemplary embodiment, represent a cumulative period of time during which the power supply supplies power to the computer and/or the cumulative runtime of any desired hardware function external of device 100.

A memory, such as a nonvolatile memory 120 can be provided as part of, or in addition to, the memory of computer 102, for storing the first parameter. In the exemplary FIG. 1 embodiment, the memory 120 can be a protected (i.e., not readily accessible) memory that is only accessed in response to control logic 114.

The memory 120 can be any desired memory including, but not limited to a nonvolatile random access memory (NVRAM), programmable read-only memory, any complementary metal oxide semiconductor (CMOS) memory, or any other desired memory. In an exemplary embodiment, the memory is non-removable so that it can function as an odometer representing the runtime of the monitored parameter. FIG. 1 shows the memory 120 as an electrically erasable programmable read only memory (EEPROM). The EEPROM can be a dedicated chip within device 100, which can coexist with another memory of a motherboard of the computer 102.

The clock 118 of FIG. 1 can be supplied power via the auxiliary power supply. The clock 118 can be used with counter 116 to measure the time period during which the power supply on input 104 and/or 105 is available. Should the power supply on input 104 and/or 105 be interrupted, the time period during which the power supply was available can be determined using the clock 118 and counter 116, and can be stored in the memory 120. For example, when an input power supply (main and/or auxiliary) which has been interrupted is again available on input 104, an additional time period (i.e., a subsequent, non-continuous time period), can be tracked and added to a previously stored time period to calculate a measure of total accumulated runtime during which the power supply has been available. A similar operation can be used to track runtime of any desired program.

In the exemplary FIG. 1 embodiment, the counter 116 can be configured to increment by one every 3600 seconds to thereby track the monitored parameter in hours. Of course, tracking by hourly increments is by way of example only, and those skilled in the art will appreciate that a runtime can be tracked in seconds, minutes, or any other desired time increment.

In operation, each 3600 second period tracked by counter 116 can be loaded into a buffered latch 124. Each hour increment can be loaded, under the control of read/write logic included in control logic 114 into the nonvolatile memory 120. In addition, information stored within the buffered latch 124 can be used to update a user interface means, such as a display 126.

In the exemplary FIG. 1 embodiment, a display 126 is illustrated as a part of the stand-alone system 100. The display can be configured to interface with the memory 120, under control of the logic 114 via any desired connection including, but not limited to, an industry standard connector, such as a cable to an external port that connects with the display. In an exemplary embodiment, the display 126 is a seven segment liquid crystal display (LCD), light emitting diode (LED) display or any other textual, alphanumeric or other user interface device.

To interface the computer 102 with the system 100, an interface 128 is provided. The interface 128 includes in an exemplary embodiment, an address decoder 130, and a nonvolatile memory 132, such as a read only memory (ROM) or other suitable memory, for storing a device identification (device ID). In addition, an address bus 134 and a data bus 136 are provided. The address bus can be used to supply address information from the computer 102 to the address decoder 128 for the purpose of identifying a hardware function of the system 100 whose runtime is to be monitored.

A buffered latch 138 can be included in the computer interface 128 to buffer data from system 100 which is input to the computer 102. The data bus 136 can be provided between the buffered latch 138 for data supplied via the system 100, to the computer 102. Runtime information of a monitored parameter can be supplied to the computer, and provided to a user, under control of the computer 102 and/or via remote access by a network manager or computer manufacturer. For example, the computer can have a separate user interface for displaying runtime information to a user and/or can have an internal, not readily accessible memory, which can be used to store a desired runtime parameter (e.g., such as the cumulative period of time during which power is supplied via the main power supply input 104 to the computer).

When power (for example, main power or auxiliary power) to the computer 102 is to be monitored, an enable input 140 of the detector can be used to enable an output from comparator 112 into the counter 116. Alternately, where a runtime of a hardware function associated with computer 102 is to be monitored, the enable signal on the enable input 140 can be used to disable the output from comparator 112. In this case, an enable input 142 can be used to enable counting within counter 116 based on a particular hardware function detected by control logic 114. The counter can continue to increment until, for example, absence of the hardware function being monitored (e.g., the hardware device is turned off to disable the enable input 142). Regardless of whether a power supply input or a runtime is being monitored, the counter can increment in like fashion, and the memory 120 can be updated via the buffered latch 124 with runtime information.

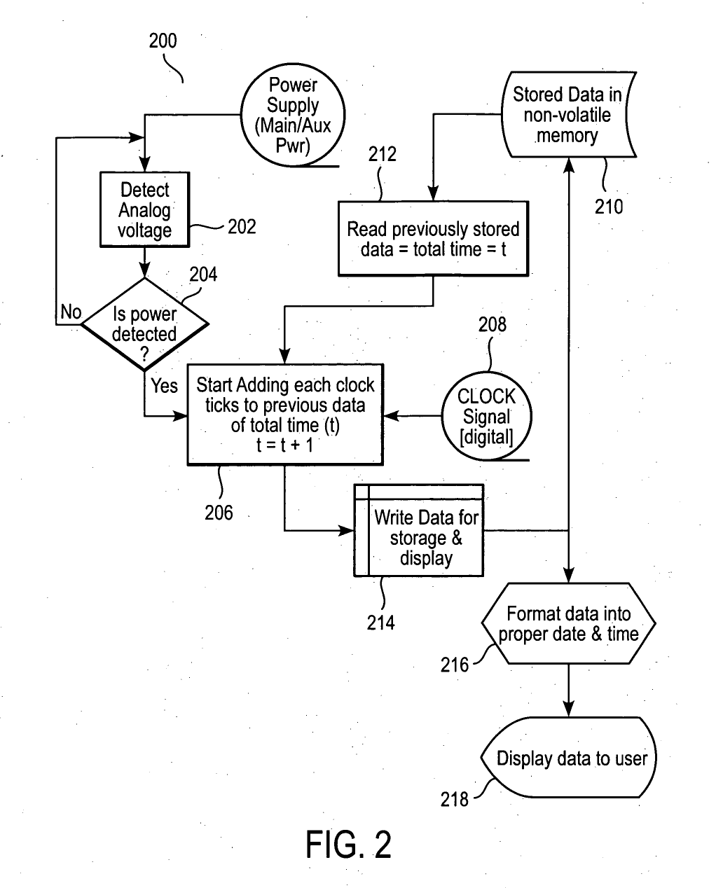

FIG. 2 shows an exemplary flowchart of an operation which can be performed using the FIG. 1 system. Referring to FIG. 2, a method 200 for monitoring an accumulated runtime in a computer is illustrated. The FIG. 2 method includes a step of detecting a supply of power from a power supply to a computer, such as the computer 102 of FIG. 1. Alternately, or in addition, a hardware function can be detected whose runtime is to be monitored.

In FIG. 2, the detecting of a supply of power from the power supply to the computer (or the detecting of a hardware function) is performed in block 202 with the detection of an analog voltage available from the power supply. For example, the FIG. 1 detector can monitor a voltage, current, power or other desired parameter from a main power supply, and compare this value with a threshold (such as 0.7 volts, or any other desired threshold) to trigger a gate (e.g., turn on a logic gate within the counter 116) which enables a measuring operation to be performed. As represented by decision block 204, if a suitable power supply (or hardware function) is detected on a particular input, clock pulses, or “ticks”, from the clock 118 in FIG. 1 (or from any desired clock source which is active) can be used to increment the counter, and an output of the counter can thereby be added to an initialized value which was stored in the memory 120 and loaded into the counter. The updating of the parameter stored in memory can be performed continuously, or at any desired interval.

Referring to FIG. 2, the initialized value of the accumulated runtime for the power supply input (or hardware function) is represented by block 210. This value can be read in block 212 as a previously stored total time value of “t”. During the availability of the power supply or during execution of a monitored program on the input being monitored, each incremental clock pulse can be added to the previous time “t” to create a new value:
t =tₚᵣₑᵥᵢₒᵤₛ+1

Thus, the FIG. 2 block 206 performs a step of determining, in response to the detecting, a first parameter representing a runtime of at least one of: a hardware function, and power supplied by the power supply to the device. Once determined, the first parameter can be stored in a memory. That is, in block 214 of FIG. 2, data representing the first parameter can be written to the memory for storage, and if desired, later displayed.

In block 216, the data which has been stored in the memory can be formatted into any desired format. For example, information can be formatted with a proper date and time for use by the user. In block 218, the FIG. 2 flowchart illustrates a step of displaying the first parameter to a user of the computer via a user interface, such as a display.

Thus, the detecting of a power supply or hardware function can include calculating a cumulative runtime of a clock during non-continuous time periods. This can be achieved by reading the last stored time from the memory 120, measuring an elapsed time the power supply is available, or the elapsed time a program being monitored is executed, using the clock 118 and counter 116, and then incrementing the value stored in the memory 120 to provide an updated parameter value.

In an exemplary embodiment, monitoring of accumulated runtime is not limited to a single power supply input, and/or hardware function runtime. Rather, any number of different power supplies and/or hardware functions can be independently monitored and stored as separate parameters in the memory 120 and/or in any desired memory or memories. For example, a first parameter stored in the memory 120 can represent a cumulative period of time during which a main power supply of the computer supplies power. Alternately, or in addition, another parameter can be used to represent a cumulative period of time during which an auxiliary power supply supplies auxiliary power to the computer.

In addition, or alternately, an active state of a hardware function associated, for example, with an operating system of the computer can be detected, and the runtime of the hardware function can be determined. A parameter can be stored to represent a time during which the hardware function is active. This parameter can also be stored in the memory associated with the computer or in the memory 120. A similar operation can be performed with respect to any hardware running on the computer. That is, a separate parameter representing a time during which a hardware component is active can be determined, and stored in memory.

In an exemplary embodiment, a user interface of the system 100 and/or computer 102 can be configured to allow the user to select any particular parameter for display, or can be configured to display all parameters. The parameters can be displayed in real time, at periodic intervals, or in asynchronous (e.g., user selected) time periods. Remote access can be provided to allow a user to remotely verify the runtime of a particular computer, such as, for example, where a computer has been leased and the owner wishes to monitor runtime of a given parameter.

In the foregoing embodiments, an exemplary system 100 has been shown as having a logic 116 which can be alternately implemented using a processor or other hardware that is programmed via software or firmware. The system 100 can alternately be configured as a field programmable gate array (FPGA) or other similar device having hardware which is programmed to perform functions described herein. The FPGA can, for example, be an embedded chip.

According to exemplary embodiments, low-level system program codes, such as a BIOS program, can be used to initiate a hardware function whose elapsed runtime is to be monitored. Calculated parameters can optionally be displayed, for example during a power on self test (POST), to a user. Such a feature provides an odometer that tracks the runtime of a specific power supply or hardware function associated with the computer.

The total runtime of the computer can, for example, be accurately monitored to provide an odometer function beginning with the date of manufacture. The monitoring of the computer runtime can, for example, be used to supplement computing on demand applications, and to offer additional information to an information technology management team. Such a function can also serve as a marketing feature for verifying that a computer has not been in operation prior to purchase. An example, a brand new computer at power up can include an automatic display as follows:
0 years, 0 months, 0 days, 0:00:00 hours.

Exemplary embodiments can also be used in leasing of computing power to track the computer use attributable to any one or more lease clients. Functions described herein can provide a backup to metering software and disclose elapsed time independently of software failures.

The odometer feature described herein can be used to display the length of time any given equipment has been running for customers. Exemplary embodiments can be coupled with Remote Insight technology and asset management information, such as serial and asset tag numbers to help identify which units are oldest. This can simplify system management, allowing older units to be removed from a network to reduce the possibility of bottlenecking.

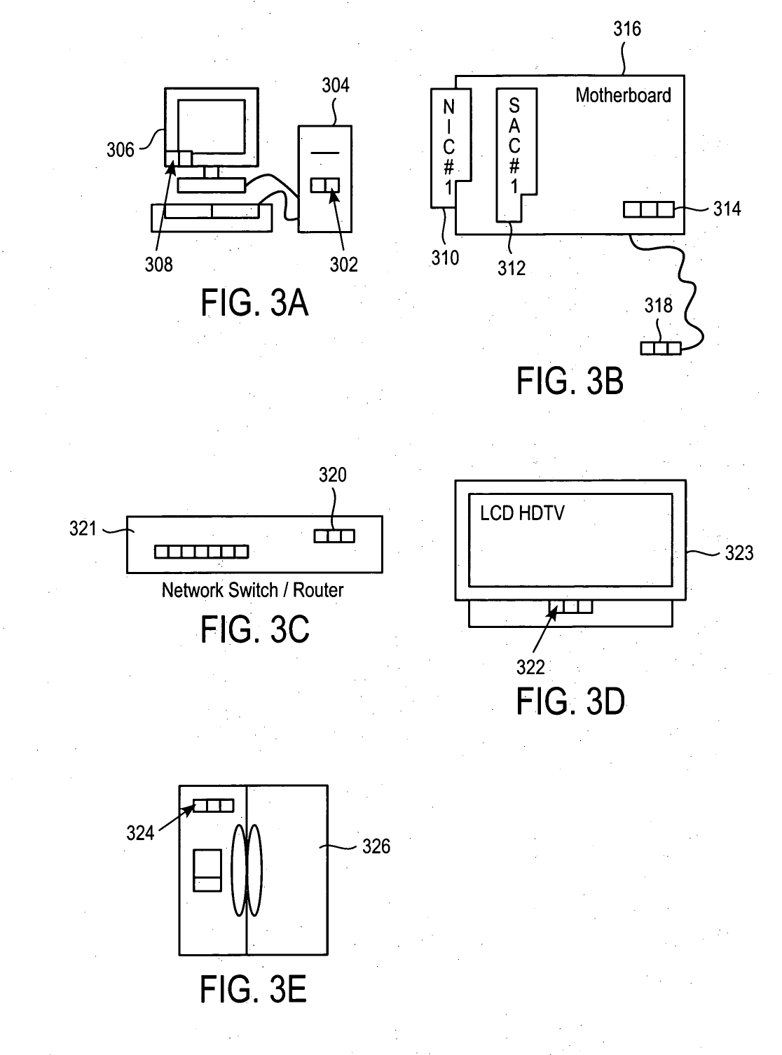

FIGS. 3A-3E show examples of devices which can be interfaced with a system, such as an exemplary system 100 of FIG. 1. For example, FIG. 3A shows an exemplary computer/server configuration, wherein runtime monitoring systems 302 and 308, as described in accordance with the FIG. 1 system 100, can be used to monitor and display runtime from any desired parameter. An exemplary runtime display of a system 302 can be included on a server 304 to display runtime of the server. In addition, a runtime of a computer 306 can be displayed on a display of a system 308 associated with the computer. Alternately, or in addition, the runtimes of any one or more hardware devices can be provided on the display of any one or more systems.

In the FIG. 3B example, the system 100 can be included as an embedded device 310 and/or 312 on a printed circuit board inserted in a motherboard 316. For example, the printed circuit board can be a network interface card (NIC), a smart array controller (SAC) card (e.g., to control multiple storage devices), or any other board. In addition, system 100 can be included as a device 314 for monitoring runtime of the motherboard itself. Any one or more runtime parameters can be presented to a user via a display included on the board and/or on a separate display 318.

FIG. 3C illustrates use of the system 100 as a device 320 for monitoring runtime of a network switch or router 321.

FIG. 3D illustrates use of a system 100 as a device 322 for monitoring the runtime of a monitor, such as a liquid crystal display used for a high definition television (HDTV) 323.

FIG. 3E illustrates use of a system 100 as a device 324 to monitor runtime of an appliance 326, such as a refrigerator.

As already mentioned, software can be used to communicate the determined runtime odometer data, or to trigger actions at specified times via additional function calls. For example, emails can be sent at certain trigger points (e.g., specified times) for preventive maintenance of the computer, to re-boot or shut down the computer at a certain timestamp, to notify when a lease has expired, and/or to display runtimes of any monitored parameter.

In an exemplary embodiment, the odometer function cannot be reset, except when desired by the owner. A reset feature can, of course, be included as an optional feature. For example, a trip reset feature can be included using an extra memory location from which data can be cleared at the request of the user.

Exemplary pseudocode for implementing functionality used to monitor a power supply runtime as described herein performs the steps of the FIG. 2 flowchart (with the exception that runtime is stored and/or displayed in years, days, hours, minutes and seconds), and can be represented as follows:

```
<CHECK POWER>:
  Does trigger voltage exist?
  If it is true go to <START>
  If it is false, loop to <CHECK POWER>
<START>:
  Read previously stored data of total time (t) {from memory}
  Add one second to previous total time (t = t +1)
  Write new total (t) back to memory for storage
  Is there a request to display data to user?
  If it is true, go to <DISPLAY>
  If it is false, go to <CHECK POWER>
<COUNTER>
  If total (t) > 60: then add 1 to mins and remainder to secs
  If mins > 60: then add 1 to hours and remainder to mins
  If hours > 24: then add 1 to days and remainder to hours
  If days > 365: then add 1 to year and remainder to days
  Show total time in YEARS: DAYS: HOURS: MINS: SECS
  Go to <CHECK POWER>
<END>
```

Similar pseudocode can of course be used to monitor any hardware function's runtime in a manner as described herein.

An exemplary function call which can be used to access data stored in the allocated memory is as follows:

strComputer = “.”
Set oWMI = GetObject(“winmgmts:\\” & strComputer)
Set sysODset = oWMI.InstancesOf(“Win32_SystemODometer”)
For Each sysODobj In sysODset
WScript.Echo “Total System Time: ” & sysODobj.TotalTime
Next

In the foregoing function call, the Windows Management Instrumentation (WMI) call is a Microsoft Windows dependent function call associated with a Windows Management (winmgmts) object. The “Set” instructions are used to access a location in memory (such as the memory 120) where a prior accumulated runtime for a given parameter has been stored. The For/Next loop performs the runtime update operation to track a total, accumulated runtime of a parameter, such as a power supply runtime or a hardware function runtime.

Those skilled in the art will appreciate that exemplary embodiments are not limited to the embodiments described herein. For example, runtime information can be polled with or without display. In addition, power supplies and/or hardware functions of any component (e.g., any hardware or software module) contained in, or associated with, any device can be separately monitored. For example, individual power supplies and replacement power supplies can be monitored to track the time during which they are connected and in use.

It will be appreciated by those skilled in the art that the presently disclosed embodiments are considered in all respects to be illustrative and not restricted. The scope of the invention is indicated by the appended claims rather than the foregoing description and all changes that come within the meaning and range and equivalence thereof are intended to be embraced therein.

What is claimed is:

1. Method for monitoring an accumulated runtime in a device, comprising:
detecting at least one of: a hardware function and a supply of power from a power supply to the device;
determining, in response to the detecting, a first parameter representing a runtime of at least one of: the hardware function, and power supplied by the power supply to the device; and
storing the first parameter in a memory associated with the device.

2. Method according to claim 1, wherein the hardware function is initiated by software running on a computer.

3. Method according to claim 2, wherein the hardware function is initiated by a basic input/output system (BIOS) program of the computer.

4. Method according to claim 2, wherein the hardware function is initiated by an operating system program of the computer.

5. Method according to claim 2, wherein the hardware function is initiated by an application program running under control of an operating system of the computer.

6. Method according to claim 2, wherein the power supply is the main power supply of a computer.

7. Method according to claim 2, wherein the power supply is an auxiliary power supply which is used to produce a main power supply for the computer.

8. Method according to claim 1, wherein the detecting comprises:
monitoring an analog voltage of the power supply using a voltage threshold.

9. Method according to claim 1, wherein the determining is performed using:
a clock which is supplied with power from the power supply; and
a counter for monitoring the runtime.

10. Method according to claim 9, wherein the determining comprises:
calculating a cumulative runtime of the clock during non-continuous time periods during which the power supply has been detected as supplying power to a computer.

11. Method according to claim 9, wherein the determining comprises:
calculating a cumulative runtime of the clock during non-continuous time periods during which an auxiliary power supply has been detected as supplying power to the computer independently of a main power supply to the computer.

12. Method according to claim 1, wherein the storing comprises:
updating a value of the first parameter.

13. Method according to claim 1, wherein the memory is a nonvolatile memory of the device.

14. Method according to claim 1, wherein the system is configured to be embedded in the device.

15. Method according to claim 1, comprising:
displaying the first parameter to a user via a user interface.

16. System for monitoring an accumulated runtime in a device, comprising:
a detector for detecting at least one of: a hardware function and a supply of power from a power supply to the device;
logic, connected to the detector, for measuring a first parameter representing a runtime of at least one of: the hardware function, and power supplied by the power supply to the device; and
memory for storing the first parameter representing the runtime.

17. System according to claim 16, wherein the device includes:
a clock which is supplied with power from the power supply; and
a counter for monitoring the runtime.

18. System according to claim 16, wherein the power supply is a main power supply of a computer.

19. System according to claim 16, wherein the power supply is an auxiliary power supply of a computer.

20. System according to claim 16, wherein the memory is a non-volatile memory.

21. System according to claim 20, wherein the nonvolatile memory is a memory accessible by a computer.

22. System according to claim 16, wherein the hardware function is initiated by software running on a computer.

23. System according to claim 22, wherein the hardware function is initiated by a basic input/output system (BIOS) program of the computer.

24. System according to claim 22, wherein the hardware function is initiated by an operating system program of the computer.

25. System according to claim 22, wherein the hardware function is initiated by an application program running under control of an operating system of the computer.

26. System according to claim 16, configured to be embedded in the device.

27. System according to claim 16, comprising:
a display for displaying the first parameter on a user interface.

28. System for monitoring an accumulated runtime in a computer, comprising:
means for detecting at least one of: a hardware function and supply of power from a power supply to the device;
means for determining, in response to the detecting, a first parameter representing a runtime of at least one of: the hardware function, and power supplied by the power supply to the device; and
means for storing the first parameter.
